(19) United States
(12) Patent Application Publication
(10) Pub. No.: US 2009/0077961 A1
(43) Pub. Date: Mar. 26, 2009

(54) Heat Concentrator Piston and Chamber

(76) Inventor: David M. Baker, Mosinee, WI (US)

Correspondence Address: LANE PATENTS LLC, 100 NORTH 72ND AVE., SUITE 107, WAUSAU, WI, 54401, US

(21) Appl. No.: 11/860,506

(22) Filed: Sep. 24, 2007

(51) Int. Cl. F01K 13/00; F02G 1/043

(52) U.S. Cl. 60/520; 60/645

(57) ABSTRACT

A piston and chamber system to be used in connection with a heat concentrator such as those used for converting low grade thermal energy into useful energy. The example apparatus disclosed herein includes a heat engine floating piston which inhibits condensation normally associated with thermodynamic cycles which run at or near vapor saturation. The resulting improvement allows increased efficiency for lower temperature systems.

### FIELD OF THE INVENTION

The present invention is directed toward apparatus used in thermal concentrators. More specifically to large piston designs for machines used in converting low grade heat into useful energy, mechanical work and the like.

### BACKGROUND

Three major technologies are currently being used for concentrating solar power generation to produce useful work; the parabolic trough, the power tower, and the sterling dish. The costs of generating electricity from these power sources are high. All three require a high working temperature, which creates problems with maintenance and seal failure rates.

With these technologies, the solar radiation is concentrated at the time of collection requiring a high working temperature at the point of collection in order to enter the chamber as superheated steam. This higher temperature generally leads to higher thermal losses, which typically forces the use of more expensive and complicated collectors and thermal storage units. This constraint leads to higher costs for construction of these devices.

With the advent of low temperature solar concentrators such as those disclosed in patent application Ser. No. 11/387,405, it is desirable to minimize condensation from saturated vapors associated with thermodynamic cycles in the heat engine cycle which run at or near the phase change point. Such improvements increase the efficiency and total power output of these systems.

It is illustrative to compare the ideal heat engine cycle described presently to a typical Carnot cycle. A Carnot cycle is a cycle that undergoes two isothermal reversible processes and two adiabatic reversible processes. However, the present heat engine cycle differs from the typical Carnot cycle in several unique ways.

A typical Carnot cycle includes an isentropic compression process during which wet steam, which consists of steam and liquid, is compressed to saturated liquid. The heat engine cycle of this embodiment includes an isentropic compression process during which wet steam, which consists of steam and liquid, is compressed until the liquid evaporates to leave only saturated vapor.

The next process is adding energy to the cycle. In the Carnot cycle the energy added, typically in the form of heat, isothermally evaporates the liquid until only saturated vapor remains. In the present cycle, only saturated vapor is present at the beginning of the energy addition process. In the present cycle, energy is added by isothermally adding mass, of saturated vapor, to the system.

A typical Carnot cycle also includes an isentropic expansion process that starts with saturated vapor and condenses to form a wet steam combination of vapor and liquid. The heat engine cycle of this embodiment also includes an isentropic expansion process during which saturated vapor is condensed to form a mixture of vapor and liquid.

The Carnot cycle's final process removes heat isothermally from the wet steam to obtain the same ratio of vapor and liquid as at the beginning of the cycle. The final process of the present invention isothermally removes heat and liquid to obtain the same ratio of vapor and liquid as at the beginning of the cycle.

In the isentropic compression process the typical Carnot cycle starts with wet steam and ends with saturated liquid, whereas the present cycle starts with wet steam and ends with saturated vapor. The disclosed process is relatively unintuitive because condensation from a vapor to a liquid is commonly associated with a compression process.

In the present cycle, the compression process must result in saturated vapor to maintain constant entropy as required by the isentropic nature of the process. In the present embodiment, only approximately 12.5% of the wet steam mixture is liquid at the beginning of the compression process. At the beginning of the process, the specific entropy of the liquid is approximately 0.53 kJ/kg-° K. and the specific entropy of the vapor is approximately 8.32 kJ/kg-° K. At the end of the compression process, the specific entropy of the liquid is approximately 1.31 kJ/kg-° K. and the specific entropy of the vapor is approximately 7.36 kJ/kg-° K. Quantitatively, an algebraic calculation equating total entropy at the beginning and end of the compression process with a single unknown of the amount of mass that changes between phases provides the result of vapor at the end of the cycle. Qualitatively, it can be seen that the relatively low percentage of liquid in the system at the beginning of the process drives the process to produce vapor. Because the majority of the system initially consists of high entropy vapor, converting all of the vapor to liquid at approximately 16% of the specific entropy can not be a constant entropy process. However, if the process produces vapor at approximately 88% of the initial vapor specific entropy, constant entropy can be maintained, with the approximately 13.9 times increase in the liquid to vapor entropy balancing the approximately 12% drop in the specific entropy of the initial vapor mass.

In a typical Carnot cycle that has a high initial percentage of liquid, the process is suboptimal. In this case, using the same starting and ending entropy values, the specific entropy of the majority of the mass, which is liquid, increases by a factor of approximately 2.5, if the final result is liquid. The mass of vapor that condenses drops in entropy by a factor of approximately 6.4 to balance out the increase in entropy of the liquid. The small drop in entropy of the initial vapor reduces the useful work which can be done by the system.

Therefore, it can be seen by one skilled in the art that there remains a large incentive to maintain as much liquid in the vapor phase as possible at the end of the process. By reducing the number of surfaces inside the chamber, including the piston head, where condensation can occur, this new cycle can be enabled with greater efficiencies as shown above.

### BRIEF DESCRIPTION OF THE DRAWINGS

FIG. 1A is an exemplary layout of a concentrator system.

FIG. 1B is an exemplary schematic block diagram of the system of FIG. 1A.

FIG. 2 is a cutaway perspective view of an exemplary thermal collector subsystem using two reservoirs.

FIG. 3 is a cutaway perspective view of an alternate thermal collector subsystem.

FIG. 4 shows a sectional view of a concentrator heat engine side with piston in top dead center of stroke.

FIG. 5 shows a sectional view of a concentrator heat engine side with piston in bottom dead center of stroke.

FIG. 6 shows a detail left side section one embodiment of one embodiment of a piston gap to liquid connecting rod interface.

FIG. 7a shows a plan schematic view of a piston head with a heater coil in an Archimedes configuration.

FIG. 7b shows a plan schematic view of a piston head with a heater coil in a Fermats' configuration.

FIG. 7c shows a plan schematic view of a piston head with a heater coil in a serpentine configuration.

FIG. 7d shows a plan schematic view of a piston head with a heater in a disk configuration.

FIG. 7e shows a plan schematic view of a piston head with a heater coil an inverted Fermats' configuration.

FIG. 8 shows a through sectional view of the piston head shown in FIG. 7d.

FIG. 9 shows an alternate embodiment exemplary floating piston.

FIG. 10a shows an alternate embodiment exemplary floating piston.

FIG. 10b shows an alternate embodiment exemplary piston wall unit.

FIG. 11a shows an exemplary thermal wall profile where the piston is at top dead center.

FIG. 11b shows an exemplary thermal wall profile where the piston is at bottom dead center.

FIG. 12 shows an exemplary P-V diagram for an embodiment of a heat engine cycle.

FIG. 13 shows an exemplary P-V diagram for an alternate embodiment of a heat engine cycle.

### DESCRIPTION

The present system utilizes a dual loop U, or other suitably shaped heat actuated liquid piston heat pump, where one leg contains part of a heat engine section and the other leg contains part of a heat pump section. But as those skilled in the art will note, it can apply to any method or apparatus which runs a thermodynamic cycle at or near the condensation point of a vapor.

These floating pistons are usually constructed from a solid material, for example, aluminum, steel, or other suitable material. They should be designed to withstand the conditions of temperature and pressure found in the system.

The heat engine section operates using a thermodynamic cycle and draws the heat energy from a natural or waste heat source, such as, but not limited to, solar energy. Fluid, typically water, in the liquid or steam form, is transferred between the solar collectors and the heat engine as part of the heat engine loop.

The heat pump loop contains the heat pump described above coupled with a device which does useful work, such as a steam turbine, which can be connected with a conversion device such as, but not limited to, an electrical generator. Water, in the form of superheated steam, is transferred from the output of the heat pump, to the inlet of the steam turbine, through the steam turbine, and from the steam turbine exhaust back to the inlet of the heat pump.

It is preferred that the input heat be at a temperature of at least 60° C. higher than the ambient temperature. The method can be used with a temperature differential lower than this, but possibly at a reduced efficiency.

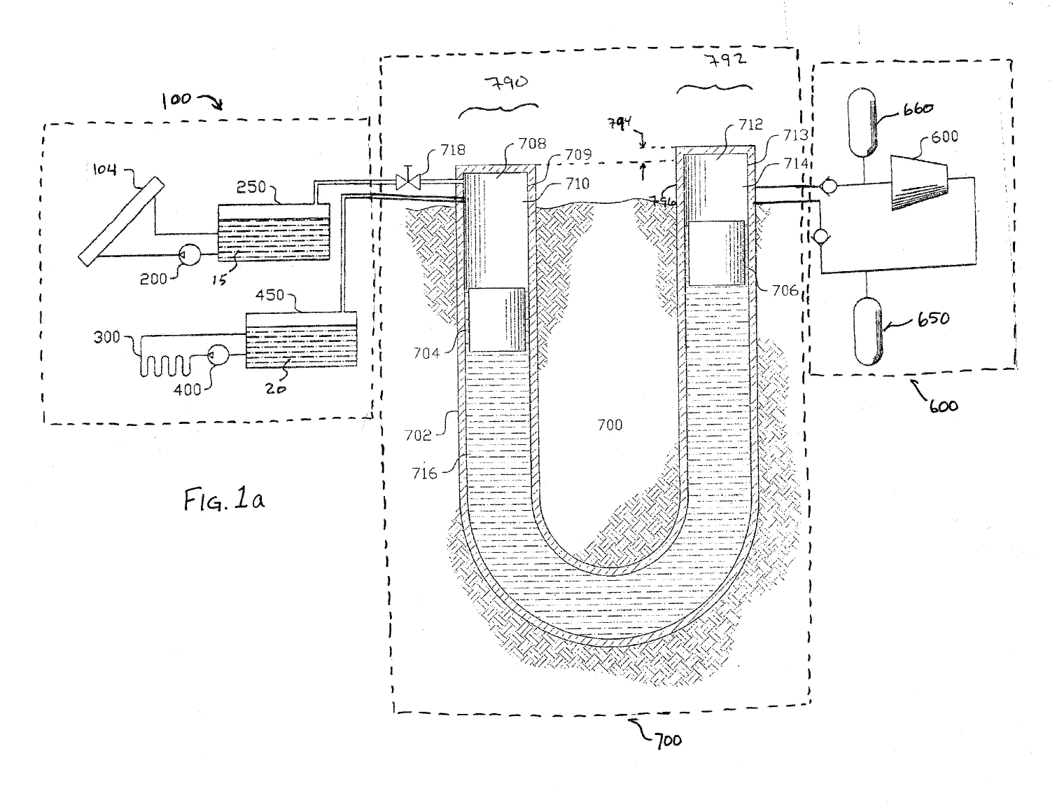

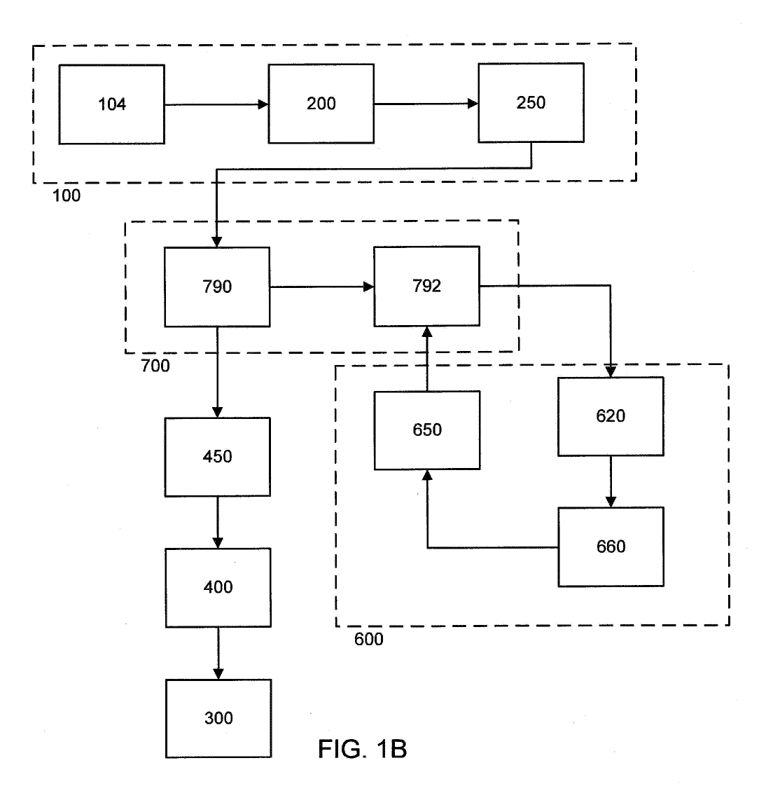

FIG. 1A and 1B show exemplary embodiments of a system 10 that generates electricity using a hot and a cold source. FIG. 1B is an exemplary schematic block diagram of the system 10. The system 10 utilizes a heating device 100 that heats a fluid 15, which is then pumped by a hot pumping device 200 to a hot thermal storage device 250. The system 10 also utilizes a cooling device 300 that cools a fluid 20 of the same material as the heating fluid 15, which is pumped by a cold pumping system 400 into a cold thermal storage device 450 after it is cooled.

The lower portion of the concentrator 700 can be constructed above or below grade and is filled with fluid, such as, water, and includes a liquid connecting rod 716. A heat engine floating piston 704 floats on the top of the liquid connecting rod 716 in one vertical leg, forming a heat engine expansion chamber 708 between the heat engine floating piston 704 and the concentrator wall 702. A heat pump floating piston 706 floats on top of the liquid connecting rod 716 in the other vertical leg, forming a heat pump expansion chamber 712 between the heat pump floating piston 706 and concentrator wall 702.

The fluid 15 from hot thermal storage device 250 is transferred to concentrator 700 and the cold fluid 20 from cold thermal storage device 450 is used to transfer heat from the concentrator 700, which cools the concentrator 700. The cold fluid 20 from the concentrator 700 may also be transferred to the cold thermal storage device 450.

The concentrator 700 heats a fluid 714 to a higher temperature than that of the fluid 15 stored in the hot thermal storage device 250. This high temperature fluid 714 is then transferred into an electric converter 600, which in one embodiment is a steam turbine, similar to the type used in a conventional steam power plant. The fluid 714 rejected from fluid to electric converter 600 is returned to the concentrator 700 where both the temperature and pressure of the fluid 714 are increased. The concentrator 700 is driven or actuated by the heat from hot thermal storage device 250.

In one embodiment of the disclosed system 10, the heat concentration is done near the time of use, such as high electric demand, rather than at the time of collection. It will be understood by one skilled in the art that many different variations and configurations of elements shown in FIGS. 1A and 1B may be used while still using the heat actuated dual loop liquid piston heat pump and steam turbine method and apparatus disclosed herein.

The pumping means 200 shown in FIG. 1B may include any type of pump, which is available commercially in various styles.

The thermal storage device 250 may be any type of reservoir capable of holding water at approximately 100° C. and approximately an atmospheric pressure of 0.1 MPa. The thermal storage device 250 may minimize the heat loss from the reservoir and substantially prevent entry of air into the reservoir.

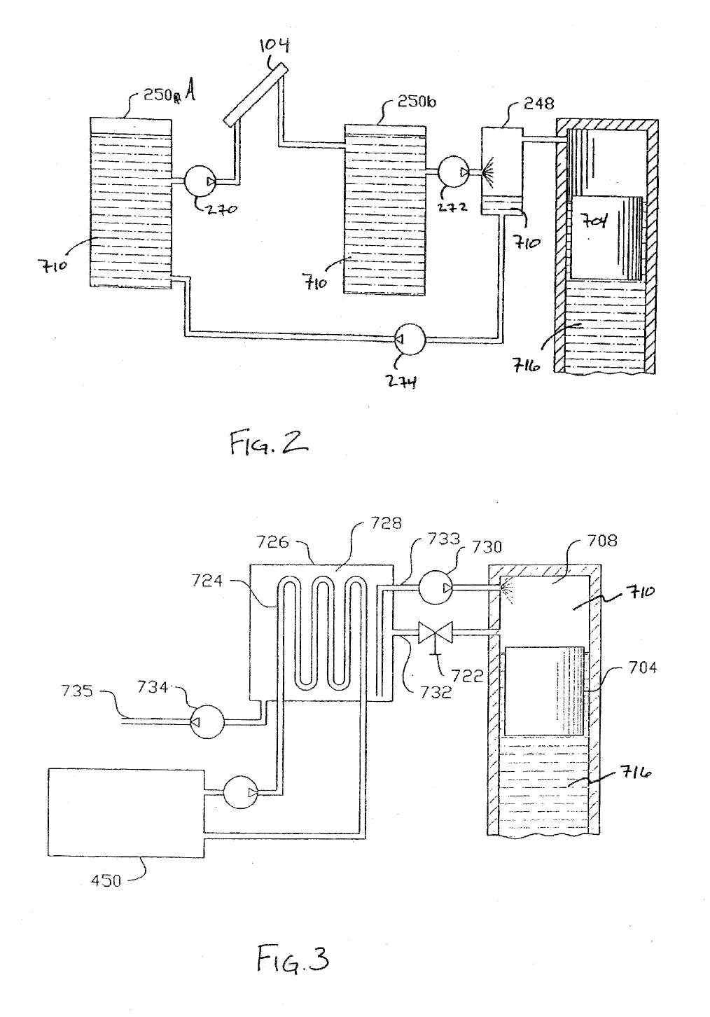

As shown in FIG. 3, an exhaust valve 722 and a piping system 732 connects the heat engine expansion chamber 708 to a heat exchanger chamber 726. The exhaust valve 722 may be controlled to turn on and off at the appropriate points in the cycle. As described below, a heat exchanger 724 is enclosed in the heat exchanger chamber 726. The heat exchanger 724 may be a standard heat exchanger as commonly known by persons of ordinary skill in the art. The heat exchanger 724 may be cooled using fluid 20 from the cold thermal storage device 450. A piping system 733 and a return pump 730 connects the heat exchanger chamber 726 and the heat engine expansion chamber 708 to pump water back into heat engine expansion chamber 708 in the form of a mist at the appropriate point in the cycle.

A piping system 735 and a pumping device 734 are connected to the bottom of heat exchanger chamber 726. The fluid 710 is pumped from the heat exchanger chamber 726, reheated in the heating device 100, and then returned to the hot thermal storage device 250.

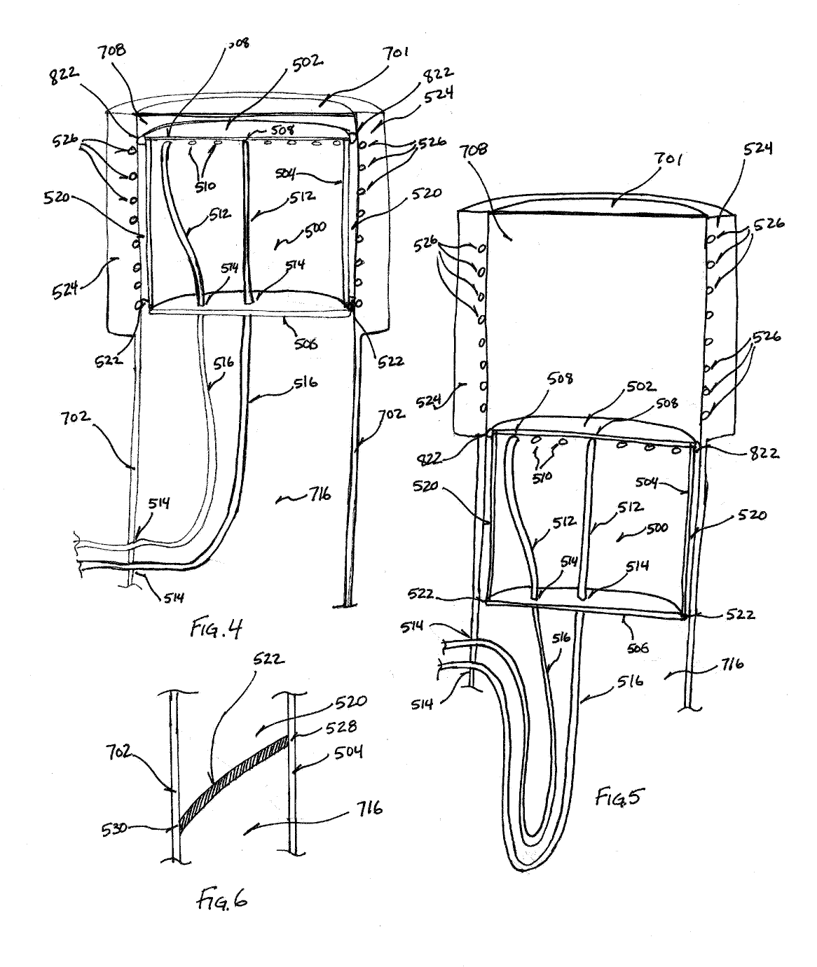

A detailed view of a heat engine expansion chamber 708 and heat pump floating piston 706 are shown in FIG. 4 which shows the piston 500 at top dead center, and FIG. 5 which shows the piston 500 at bottom of stroke. The drawings focus on the heat engine 790 side of the concentrator 700, which is only partially shown. But by analogy it can also be applied to the piston on the heat pump 792 side. This system is designed to minimize condensation on the piston head and chamber for reasons discussed in the background portion of the specification. In this embodiment, the piston 500 comprises a piston top 502 which is integrally coupled with a piston head conduit 510 which circulates vapor at the conditions found at the inlet valve 718 (not shown).

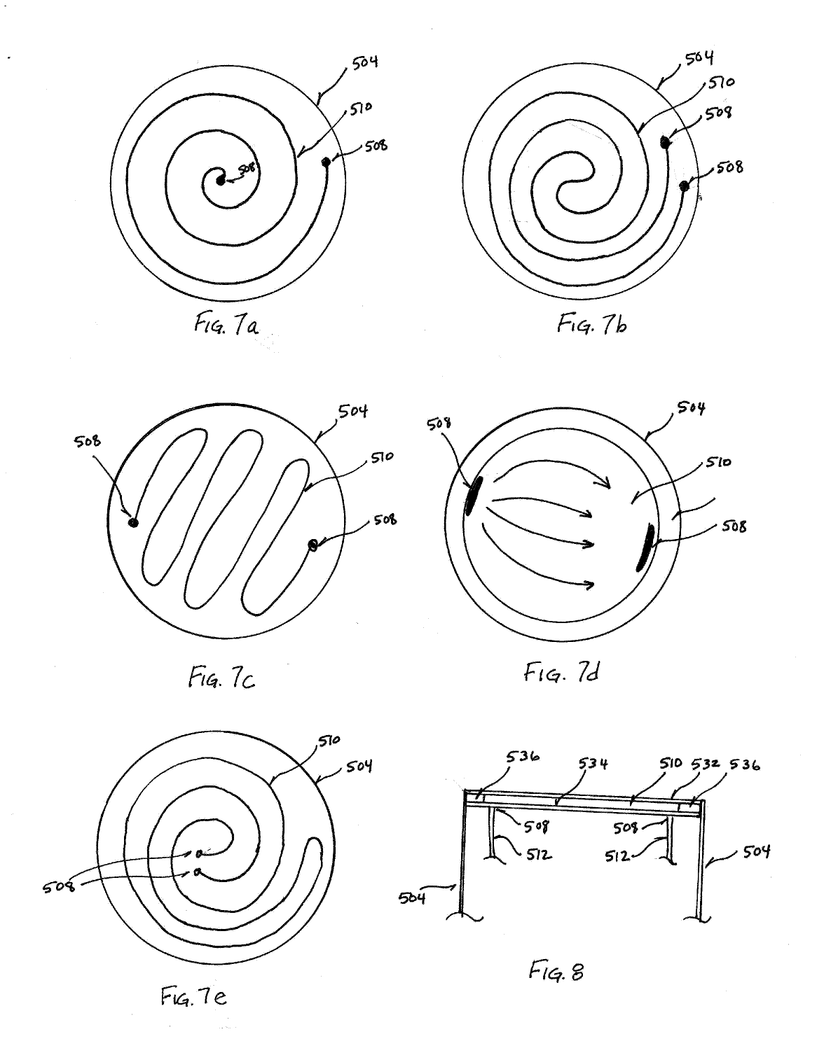

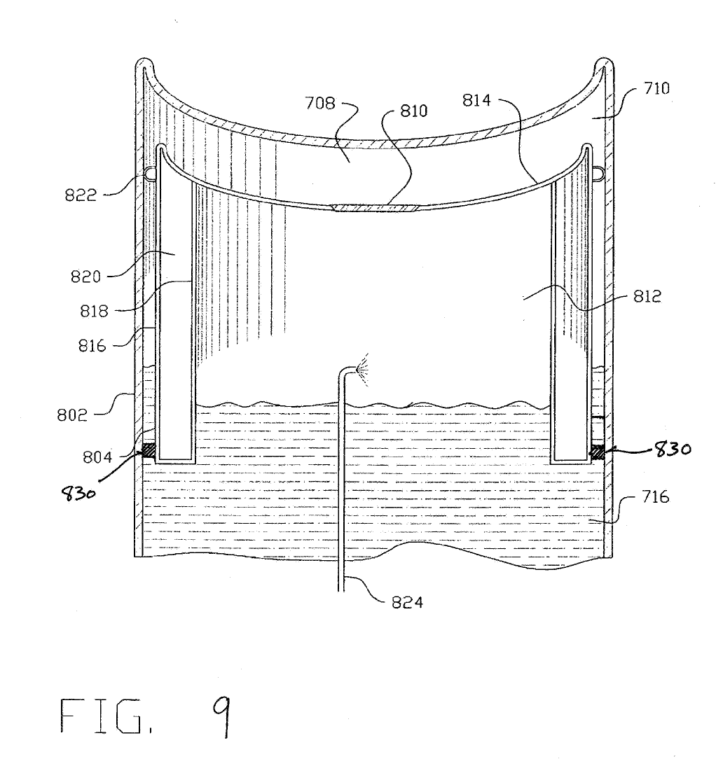

The piston head conduit 510 can take any of several forms as shown in FIG. 7a,b,c,d sufficient to assure a good thermal transfer between the piston head conduit 510 and the piston head 502. The conduit is preferably standard ¼ inch copper or aluminum tubing suitable for plumbing applications.

The piston side(s) 504 extend between the piston top 502 and the piston bottom 506, and are predetermined in length to extend approximately the length of the stroke. If the zone is too short then efficiency is decreased. If too long then the over all size of the system increases and the cycle time per stroke. The diameter of the cylinder created by the piston sides 504 should be approximately 4 to 20 mm smaller than the diameter of the concentrator wall 702. Those skilled in the art will appreciate that the final determination of this diameter be a function of the desired piston to wall gap 520 for the creation of steam in the piston to wall gap 520 during the upstroke of the piston 500 as shown in FIG. 4 and are dependent upon the final sizing of the system. The piston top 502, piston side 504, and the piston bottom 506 should be constructed in such a way as to be water tight.

Internal conduit 512 are integrally connected with the piston head conduit 510 and extend between the piston top and bottom where it flows through an interface seal 514 which serves to allow a water tight seal between the internal conduit 512 and the piston bottom 506. Below the piston bottom 506, flexible tubing 516 should be used to allow for movement of the piston. The flexible tubing 516 then exits the concentrator wall 702 through a separate interface seal 514 in order to assure integrity of the system.

Alternate Embodiment

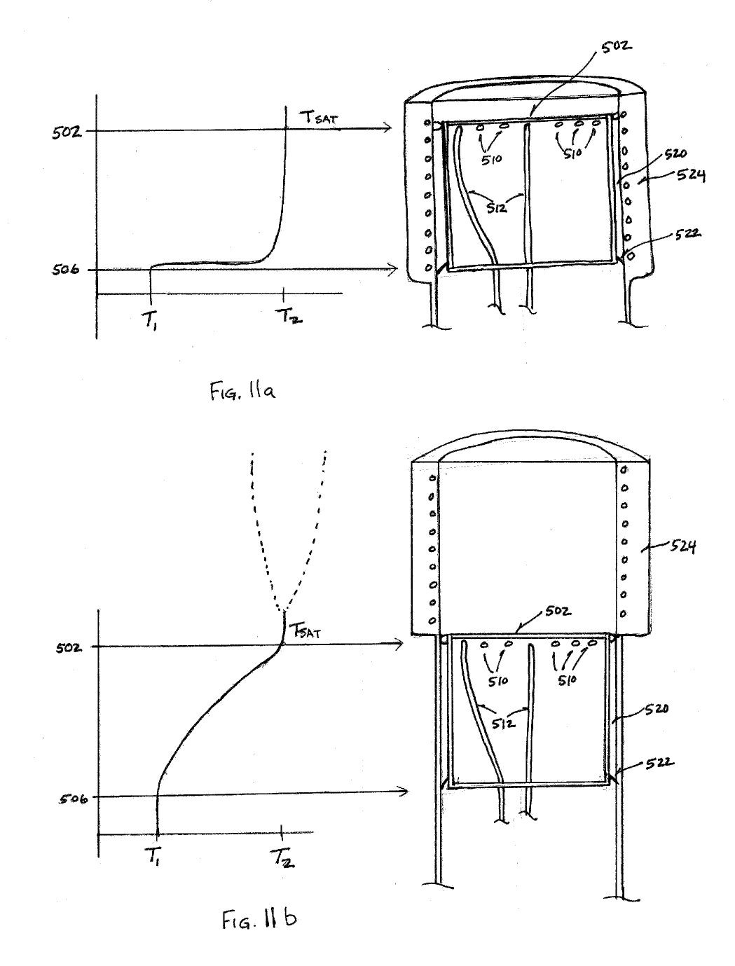

As shown in FIG. 10a, heat engine floating piston 704 has a piston top member 760, which includes the bottom wall of heat engine expansion chamber 708. Beneath the piston top member 760 is a layer of piston insulation 762. The piston insulation 762 should be sufficient reduce heat loss through the piston top member 760. The density of the piston insulation 762 may also play a role in determining the depth at which heat engine floating piston 704 floats. Beneath the piston insulation 762 is a piston sealing member 764, which serves to seal the cavity formed by the piston sealing member 764 and the piston top member 760. A plurality of piston vertical supports 766 may run between the piston top member 760 and the piston sealing member 764, to support them against operational pressure. In this embodiment, the piston top member 760, the piston sealing member 764, and the piston vertical supports 766 are made of aluminum. These members together form a piston top assembly 759.

The piston top assembly 759 is connected to a piston structure 768. A plurality of piston wall units 770 are fastened to a circumference of the piston structure 768, providing a thermal barrier between the heat engine expansion chamber wall 709 and the part of liquid connecting rod 716 that is inside the heat engine floating piston 704.

An example of the piston wall unit 770 is shown in more detail in FIG. 10b. The piston wall unit 770 includes a wall member 772, which may be constructed of die cast aluminum, and a sealing plate 778. The wall member 772 may be a single unit including an outer wall 774 and a series of supporting ribs 776. The sealing plate 778 may also be an aluminum sheet welded to the wall member 772 to form a substantially airtight seal. Additionally, the interior of the piston wall units 770 may be air or a vacuum to reduce heat transfer. Still further, the interior of piston wall units 770 may be filled with a closed cell water resistant material. It will be appreciated by persons skilled in the art that any suitable thermal barrier may be used between the heat expansion chamber wall 709 and the heat engine floating piston 704. A seal material 780, such as rubber, nylon, or other suitable material, may be placed between the piston wall units 770 during assembly to substantially prevent the flow of water from the gap between the heat engine expansion chamber wall 709 and the heat engine floating piston 704 to the interior of the heat engine floating piston 704.

The heat engine floating piston 704 may provide a small gap, sufficient to inhibit heat transfer, approximately 2 mm in this example, between the outer surface of heat engine floating piston 704 and the inner surface of concentrator wall 702. This gap may influence the efficiency of the system, as discussed below.

To facilitate the efficiency of the system, a gap seal 522, as shown in FIG. 6, may be added to keep liquid from the liquid connecting rod 716 from entering the piston wall gap 520. The gap seal 522 should be designed to fit around the lower perimeter of the piston 500 near the piston bottom 506 as shown in FIG. 4 and 5.

The gap seal 522 may also be oriented such that any excess pressure by steam generated during the upstroke will be relieved across the gap seal 522 and into the mass of the liquid connecting rod 716, similar to the action of a flapper valve. In one embodiment, the gap seal 522 can extend around the perimeter near the bottom of the piston side 504 and with a fixed end 528 attached to the piston 500 and the free end 530 able to move relative to the concentrator wall 702.

Thermodynamic Cycles

A flowchart representative of an example process to implement the system of FIGS. 1A and 1B, is shown in FIG. 12. In this example, the process and/or machine readable instructions comprise a program for execution by a processor, controller, or similar computing device as described above. Generally speaking, the process acquires and stores thermal energy via one or more heat collectors 100. The acquired and stored thermal energy is provided to a concentrator 700, which includes a heat engine to drive a heat engine piston through various thermodynamic processes. The heat engine transfers energy to the heat engine floating piston 706 via a liquid connecting rod 716 of the concentrator 700. Such energy transfer to the heat pump floating piston 706 further delivers energy to an electrical generating unit 600 to produce electricity.

In view of FIG. 12 and starting with the liquid connecting rod 716 and the heat engine floating piston 804 at top dead center, the inlet valve 718 is opened allowing the flow of steam from the hot thermal storage device 250 into the heat engine expansion chamber 708. In the ideal cycle, this flow occurs in an isothermal, isobaric, and isentropic manner. This section of the cycle is labeled as Process 1, Isothermal Expansion in FIG. 12. At the beginning of Process 1, the heat engine fluid 710 may be a saturated vapor at approximately 364° K. and approximately 0.072 MPa and the heat engine expansion chamber. The heat engine 790 supplies work to the liquid connecting rod 716 during this phase of the cycle.

After the liquid connecting rod 716 has moved down to expand the heat engine expansion chamber 708, the inlet valve 718 is closed starting Process 2, Isentropic Expansion. Process 2 is expansion of the heat engine fluid 710 in the heat engine expansion chamber 708 along the saturation curve. At the beginning of Process 2, the heat engine fluid 710 is still saturated vapor at approximately 364° K. and approximately 0.072 MPa. As the heat engine expansion chamber 708 expands, the pressure and the temperature of the heat engine fluid 710 drop and a part of the heat engine fluid 710 begins to change from the vapor and/or steam phase to liquid water. As the heat engine expansion chamber 708 continues to expand, the temperature and the pressure continue to drop and additional steam is changed to liquid water. In this example, the temperature of both the steam and the liquid phase drops at the same rate as the heat engine expansion chamber 708 expands. The heat engine supplies work to the liquid piston during this phase of the cycle. Controlling the temperature of both the steam and the liquid phase to drop at the same rate may be accomplished using several different methods. In this example, the concentrator wall 702 in the region of the heat engine, and the piston 500 are maintained at a temperature above the saturation point so the liquid water will have no surface on which to condense and will basically form a fog or liquid suspended in vapor.

When the piston 500 reaches the bottom of the stroke, Process 3 begins as the heat engine exhaust valve 810 is opened, connecting the heat engine expansion chamber 708 to the condensation chamber 812. In this example, the temperature and pressure in the condensation chamber 812 is lower than temperature and pressure in the heat engine expansion chamber 708 when the heat engine exhaust valve 810 opens. Additional condensation in the condensation chamber 812 occurs, causing the temperature and the pressure in the heat engine expansion chamber 708 to rapidly drop which is shown as condensation at constant volume in Process 3. In practice, the volume changes slightly during Process 3, but the change in volume is minimal.

As the heat engine floating piston 804 begins its upward stroke due to inertial forces of the system 10, Process 4, Isothermal Compression starts as shown in FIG. 12. At the beginning of Process 4, the heat engine fluid 710 is a mixture of liquid and vapor at approximately 300° K. and approximately 0.0038 MPa and the heat engine expansion chamber 708 is at a volume of approximately 1.71 m³ in one embodiment of the system. The heat engine expansion chamber 708 begins to decrease in volume, compressing the heat engine fluid 710. As the steam begins to compress, the temperature and the pressure rise incrementally and the steam will begin to condense in the condensation chamber 812. Sufficient heat is transferred out of the system 10 through the condensation process so that this process proceeds isothermally. The liquid piston supplies work to the heat engine during Process 4. At the end of Process 4, the heat engine fluid 710 is at approximately 301° K. and approximately 0.0038 MPa.

After the proper amount of heat and mass have been transferred during Process 4, the exhaust valve 810 is closed, isolating the heat engine expansion chamber 708 from the condensation chamber 812. Closing the exhaust valve 810 causes the start of Process 5, Isentropic Compression. At the beginning of process 5, the heat engine fluid 710 includes a mixture of liquid and vapor at a temperature of approximately 300° K. and a pressure of approximately 0.0038 MPa. As the heat engine floating piston 804 continues upward, compression of the heat engine expansion chamber 708 is continued. The heat engine expansion chamber 708 contains a mixture of liquid and steam at this point in the cycle. During Process 5, the liquid evaporates and the heat engine fluid 710 becomes a saturated vapor at a temperature of approximately 364° K. and a pressure of approximately 0.072 MPa. When the heat engine floating piston 804 reaches the top of its stroke, the process repeats in an iterative manner.

It can be noted that all four heat engine processes occur on the saturation line. The processes that are isentropic are only isentropic when both the liquid and vapor phases are considered.

Condensation can be prevented by maintaining the temperature of the heat engine expansion chamber wall 709 and the heat pump expansion chamber wall 713 at or above the saturation temperature for the highest pressure point in the cycle. This is also applicable to the top face of the heat engine floating piston 704 and the heat pump floating piston 706. As shown in FIG. 10a and 10b, using an adequate amount of insulation behind the wall and below the top of the piston, heat transfer losses may be lowered.

The thermal mass of the wall of the heat engine expansion chamber 708 will normally be much higher than the thermal mass of the combination of that part of the liquid connecting rod 716 which is located between the heat engine expansion chamber 708 and the heat engine floating piston 704 and the outer wall of the heat engine floating piston 704. It may be advantageous to reduce the mass of the liquid connecting rod 716 and the heat engine floating piston 704 in the described area. When the liquid connecting rod 716 is at the top stroke of the heat engine, the liquid at the top of the liquid connecting rod 716 between the heat engine floating piston 704 and the heat engine expansion chamber wall 709 may be at a slightly lower temperature than the adjacent section of the heat engine expansion chamber wall 709. Heat will flow from the heat engine expansion chamber wall 709 into the adjacent element of the liquid connecting rod 716. As the liquid connecting rod 716 begins to drop, this same element will now be adjacent to a lower and colder section of the heat engine expansion chamber wall 709. Heat will flow from the element of liquid connecting rod 716 into the adjacent element of the heat engine expansion chamber wall 709. Due to the differences in thermal mass, this typically will cool the element of the liquid connecting rod 716 and slightly raise the temperature of the element of the heat engine expansion chamber wall 709. This process may continue as the liquid connecting rod 716 continues to drop, until the same element of the liquid connecting rod 716 is completely cooled by the time that it reaches the bottom of the stroke.

The process is reversed on the upward stroke of the liquid connecting rod 716. As the piston 500 is pushed upward, it moves into the zone adjacent to a warmer element of the heat engine expansion chamber wall 709. This will continue as the liquid connecting rod 716 rises, with the result that the element of the liquid connecting rod 716 will be nearly at the maximum temperature of the heat engine expansion chamber wall 709 when it reaches the top stroke.

With the process described herein, only a very small amount of heat is added to the system during each stroke because almost all of the heat required to heat the portion of liquid connecting rod 716 in the gap between the heat engine floating piston 704 and the heat engine expansion chamber wall 709 is recycled between the element of liquid connecting rod 716 and the heat engine expansion chamber wall 709 during the cycle.

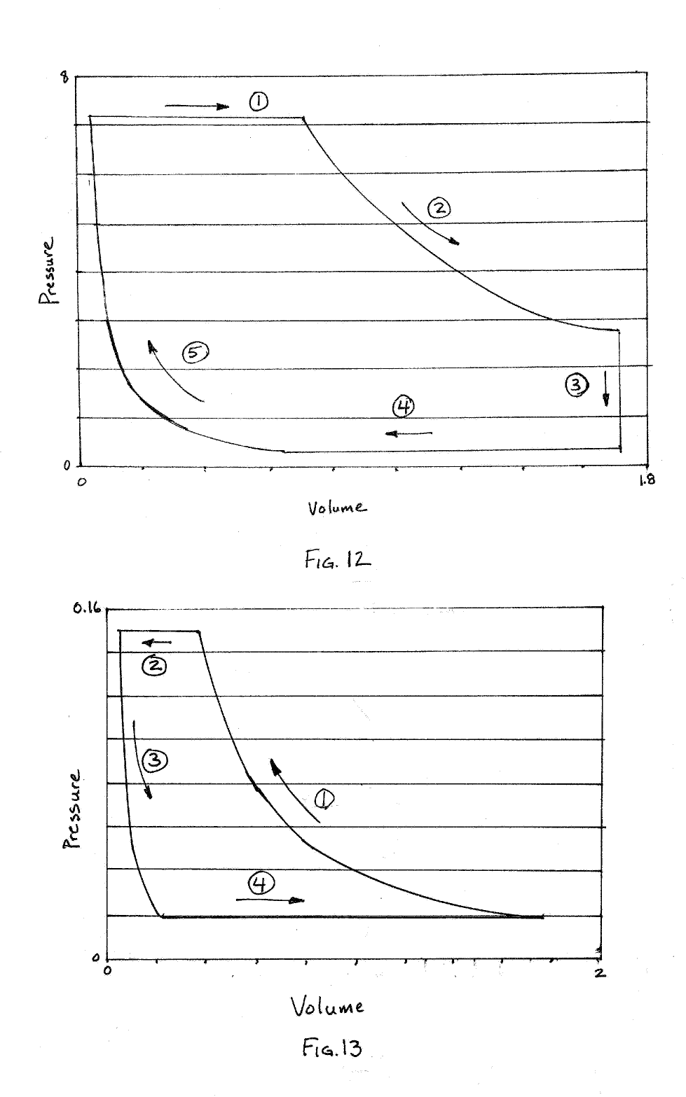

A similar process occurs for the outer wall of the heat engine floating piston 704, with the outer wall transferring heat back and forth through the liquid connecting rod 716 to the heat engine expansion chamber wall 709 during each cycle. Having steam or vapor in the piston to wall gap 520 increases efficiency for the system by minimizing heat transfer between the concentrator 702 and the piston 500 by achieving a lower thermal mass and relying upon vapor phase transfer as opposed to liquid wetting and conduction, it also provides a buffer between the piston bottom 506 which is constrained in temperature by the liquid connecting rod, and the piston top 502 which is bounded by the heat carried by the piston head conduit. The result being reduced condensation around each piston head and chamber. An advantage of minimizing the condensation around the piston head and chamber, is to increase the efficiency of the system by keeping the thermodynamic cycle at or near the condensation point of the working fluid. A further advantage is that steam entering the chamber need not be superheated to inhibit condensation. FIGS. 11a and 11b illustrate how reduction of condensation around a piston head and chamber is achieved.

FIGS. 11a and 11b show an exemplary thermal wall profile, illustrating how heat transfer is minimized between the piston side 504 and the concentrator wall 702 of the heat engine 790. The same profiles may apply to the piston and wall on the heat pump 792 side, by analogy. FIG. 11a shows the profile for a piston 500 at top dead center of the heat engine expansion chamber 708. FIG. 11b shows the profile for a piston 500 at bottom dead center of the heat engine expansion chamber 708. In both profiles, T₁ represents the temperature of the boundary condition of the liquid connecting rod 716. T₂ represents the temperature of the boundary condition of the heat engine expansion chamber 708. T_{SAT} represents the saturation temperature of the liquid connecting rod 716 whereby condensation is vaporized. T₂ is greater than T₁ in both profiles because the temperature inside the chamber 708 is constantly maintained at or near its initial temperature by chamber wall conduits 526 and piston head conduits 510. The profiles plot T₁ and T₂, as measured along the piston side 504, from the piston bottom 506 to the piston top 502.

The optional housing structure 524 can be made of any structural or insulative material designed to retain the heat near the chamber 708 wall. The structure 524 is lined with chamber wall conduits 526, which vaporize the liquid connecting rod 716, as the liquid makes contact with the structure 524. The temperature of the structure 524 is higher than that of the concentrator wall 702 because of the conduits 526. T_{SAT} is achieved at the piston top 502 in both FIGS. 11a and 11b. Thus, condensation reduction, i.e. vaporization, occurs inside the heat engine expansion chamber 708, regardless of how the position of the piston 500 changes relative to the chamber 708. A difference in how T_{SAT} is achieved between FIGS. 11a and 11b, is the rate at which T2 is achieved in relation to T1 along the piston side 504.

In FIG. 11a, the piston 500 is located at top dead center of the chamber 708 and the liquid 716 between the piston 500 and the structure 524 is vaporized because of the conduits 526. The temperature along the piston side 504, quickly approaches T_{SAT} because each point along the piston side 504 is adjacent to the conduits 526, which are maintained at the same temperature as T_{SAT}. Accordingly, vaporization occurs in the piston to wall gap 520.

In FIG. 11b, the piston is located at bottom dead center of the chamber 708 and the concentrator 702 is cooler than the piston side 504. The temperature along the piston side 504 resembles a more linear relationship than that in FIG. 11a, in part because of the lack of conduits in the concentrator 702, which has a cooler surface relative to the structure 524 and piston side 504. T_{SAT} is still achieved where the piston side 504 meets the piston top 502, because of how the temperature is maintained in the chamber 708 with conduits 526 and 510. When the piston 500 moves from top dead center to bottom dead center, vapor is created inside the piston to wall gap 520, inhibiting heat transfer from the piston side 504 to the concentrator 702 because the intermediate vapor has a temperature at or above T_{SAT}.

Internal Spray Embodiment

The heat engine floating piston 804 and the heat pump floating piston 706 are constructed to reduce the thermal mass exposed to the heat engine expansion chamber wall 709.

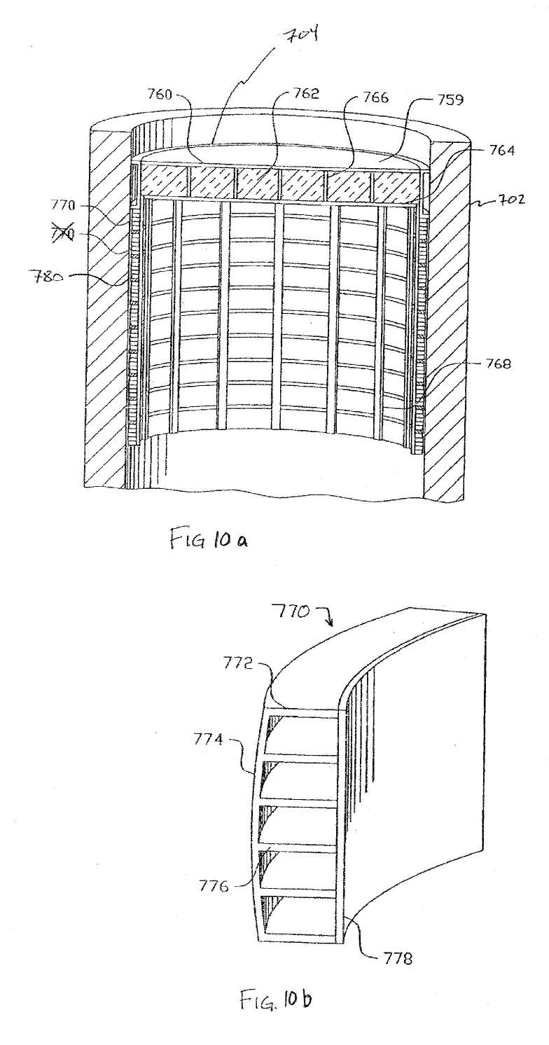

As shown in FIG. 9, the heat engine floating piston 804 has a piston top member 814, which includes the bottom wall of the heat engine expansion chamber 708. The piston top member 814 is connected to a piston outer wall 816, which is designed such that the height substantially matches the length of the stroke. In this example, the piston outer wall 816 is formed from rolled and welded aluminum sheet approximately 1.5 mm thick. The piston inner wall 818 is also formed from rolled and welded aluminum sheet approximately 1.5 mm thick. The gap 820 between the piston outer wall 816 and the piston inner wall 818 provides a thermal barrier between the concentrator wall 802 and the part of liquid connecting rod 716 that is inside of the heat engine floating piston 804. The heat engine floating piston 804 is designed and built to provide a small gap, approximately 2 mm, between the outer diameter of the heat engine floating piston 804 and the inner diameter of the concentrator wall 802. A piston seal 822 may be located near the top of the heat engine floating piston 804 to minimize condensation and evaporation effects from the concentrator wall 802.

An exhaust valve 810 may connect the heat engine expansion chamber 708 to a condensation chamber 812. The exhaust valve 810 can be controlled to turn on and off at the appropriate points in the cycle. A spray system 824 may be located in the condensation chamber 812. When the exhaust valve 810 is opened, liquid from liquid connecting rod 716 is sprayed into the condensation chamber 812 to cause condensation of the heat engine fluid 710. Heat is removed from the liquid connecting rod 716 either by using a conventional heat exchanger or by circulating fluid through the liquid connecting rod 716 and cooling the fluid, for example, at night using cooling device 300.

Although certain example methods, apparatus, and articles of manufacture have been described herein, the scope of coverage of this patent is not limited thereto. On the contrary, this patent covers all methods, apparatus and articles of manufacture fairly falling within the scope of the appended claims either literally or under the doctrine of equivalents.

We claim:

1. A method for controlling condensation in a heat engine which performs thermodynamic processes on collected thermal energy comprising:
collecting thermal energy in the form of a vapor;
transferring the collected thermal energy to a concentrator, the concentrator comprising a heat engine, said heat engine comprising a piston,
said piston being operatively coupled with a liquid connecting rod;
and invoking an oscillating cycle of the heat engine, and the liquid connecting rod,
wherein at least one of said piston and said heat engine are maintained substantially at or above the saturation temperature of the vapor.

2. A method as defined in claim 1 wherein invoking the oscillating cycle of the heat engine further comprises controlling a heat engine piston through at least one of;
an isothermal expansion phase,
an isentropic expansion phase,
a constant volume compression phase,
an isothermal compression phase,
or an isentropic compression phase.

3. A method as defined in claim 2 wherein the isentropic expansion phase further comprises maintaining at least one of the heat engine piston or walls of the concentrator at a temperature to prevent liquid condensation.

4. A method as defined in claim 1 wherein invoking the oscillating cycle of the heat pump further comprises controlling a heat pump piston through at least one of an isentropic compression phase, an isothermal compression phase, an isentropic expansion phase, or an isothermal expansion phase.

5. A method as defined in claim 1 wherein the oscillating cycle of the heat engine comprises a heat engine piston to ascend and descend, and the oscillating cycle of the heat pump further comprises a heat pump piston to at least one of descend in response to the heat engine piston ascension and ascend in response to the heat engine piston descension.
